(19) United States
(12) Patent Application Publication
(10) Pub. No.: US 2009/0055116 A1
(43) Pub. Date: Feb. 26, 2009

(54) Method For Inspecting Appearance Of Pellet Type Medicines And System Employing Thereof

(76) Inventors: Chou-Pi Chen, Taichung (TW); Chein-Ming Lin, Taipei (TW)

Correspondence Address: APEX JURIS, PLLC, 12733 LAKE CITY WAY NORTHEAST, SEATTLE, WA, 98125, US

(21) Appl. No.: 11/844,523

(22) Filed: Aug. 24, 2007

(51) Int. Cl. G06F 19/00

(52) U.S. Cl. 702/82

(57) ABSTRACT

A method for inspecting appearance of pellet type medicines and a system employing thereof are provided, in which after the pellet type medicines are arranged into a row, they are sequentially slid down via an oriented sliding channel and then collected after dropping, wherein when the pellet type medicines move on the oriented sliding channel, an image processing device classifies the pellet type medicines according to records of detecting signals and gathered images, and controls the operation of a classification controlling device related to the appearance defective pellet type medicines, so as to depart the appearance defective pellet type medicines from the dropping pathway.

### FIELD OF THE INVENTION

The present invention is related to an appearance inspection technology for pellet type medicines, and more particularly to a method for rapidly and automatically screening the appearance of pellet type medicines and a system employing thereof.

### BACKGROUND OF THE INVENTION

Industrial revolution significantly promotes the technology in human society, and then, the manpower is replaced by machine. And, owing to the machine, we can make a product with finer size and more beautiful appearance. Now, the operation, including the procedures and parameters for product fabrication, of machine can be controlled by pre-written computer programs so that the manufacturing process becomes automation and the product can be produced more effectively with greater amount.

Although the composition of product can be controlled more precisely, such as pills, owing to the more progressive manufacturing technology, the consumer oppositely will request more about the appearance of the product.

Pellet type medicine (such as capsule and pill) has already produced automatically, but the final appearance inspection still counts on manpower and visual examination for picking out the defective ones. This traditional method needs lots of young laborers with highly paid attention and concentration. However, after a continuous long-term concentration, such as one hour's continuous focus on the products, human's vision becomes tired and declined. Therefore, there needs lots of laborers for alternation and for repeated inspection, so as to reduce mistakes.

Currently, some new inspection machines can developed, in which the common way is to utilize different tools (such as different indentations) to inspect capsules and pills in different sizes. Thus, when it needs to inspect products in different standard, the mechanic capability is required to change the inspection tools, which wastes not only time but also manpower. Alternatively, the manufacturer has to buy machines with different inspection sizes, which also consumes cost.

According to the drawbacks of the inspection machine described above, the traditional inspection method is still the main inspection manner in the market. Consequently, it really needs an inspection system which can be assembled conveniently and adapted to pellet type medicines in various sizes for reducing the examination cost.

### SUMMARY OF THE INVENTION

The object of the present invention is to provide a method for inspecting the appearance of pellet type medicines and a system employing thereof, so as to automatically screen the appearance of plural pellet type medicines.

Another object of the present invention is to provide an appearance inspection system which can be adapted to pellet type medicines in various sizes, so as to automatically screen the appearance of plural pellet type medicines, and thus, reduce the examination cost.

For achieving the objects described above, the present invention provides a method for inspecting appearance of pellet type medicines. The method includes steps of: arranging the pellet type medicines into a row, and sequentially sliding down the arranged pellet type medicines via an oriented sliding channel and collecting the dropped pellet type medicines, wherein when the pellet type medicines move on the oriented sliding channel, an image processing device classifies the pellet type medicines according to records of detecting signals and gathered images, and controls the operation of a classification controlling device related to the appearance defective pellet type medicines, so as to depart the appearance defective pellet type medicines from the dropping pathway.

For achieving the method described above, the present invention provides a system including a material supplying device for providing the pellet type medicines, which can be capsules or pills, an arranging device for receiving the pellet type medicines from the material supplying device and arranging thereof into a row, an oriented sliding channel connected to the arranging device for guiding the pellet type medicines to slide down and having an inspecting region located at the end there, a detecting device mounted aside the oriented sliding channel for sensing each of the slid-down pellet type medicines on the oriented sliding channel, at least two image gathering devices located around the inspecting region for gathering appearance images of the pellet type medicines, which slide to the inspecting region, from multiple angles, a classification controlling device mounted at the rear end of the inspecting region for picking out the pellet type medicine with defective appearance when at least one of the image gathering device gathers the image showing the defective appearance of the medicine, a material collecting device mounted below the oriented sliding channel for collecting the screened pellet type medicines, and an image processing device electrically connected with the detecting device the image gathering devices and the classification controlling device for classifying the pellet type medicines according to the records from the detecting device and the image information obtained by the image gathering devices, and for controlling the operation of the classification controlling device related to the appearance defective pellet type medicines so as to depart the appearance defective pellet type medicines from the dropping pathway, wherein the classification controlling device includes a gas nozzle for blowing the appearance defective pellet type medicines away the dropping pathway.

Plural illuminating devices are mounted around the image gathering devices for providing light to the inspection region.

The material collecting device further includes a good product collecting device for collecting the pellet type medicines with good appearance and a defective product collecting device, located aside the good product collecting device, for collecting the pellet type medicines with defective appearance.

The present invention can rapidly and automatically inspect and screen the appearance of plural pellet type medicines through dynamically gathering the images of medicines. Only by adjusting the number and angle of the image gathering devices and by flexibly modifying the settings of image processing and analysis and the settings of defective parameters, the present invention can be applied to inspect and screen the appearances of various sizes of pellet type medicines, and in practice, for improving inspection speed and quality, a criterion for judging the defects also can be generated through statistic calculation.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing a system for inspecting appearance of pellet type medicines according to the present invention;

FIG. 2 is a schematic view showing an arrangement for gathering images of capsule type medicines according to the present invention; and

FIG. 3 is a schematic view showing an arrangement for gathering images of pill type medicines according to the present invention.

### DESCRIPTION OF THE PREFERRED EMBODIMENT

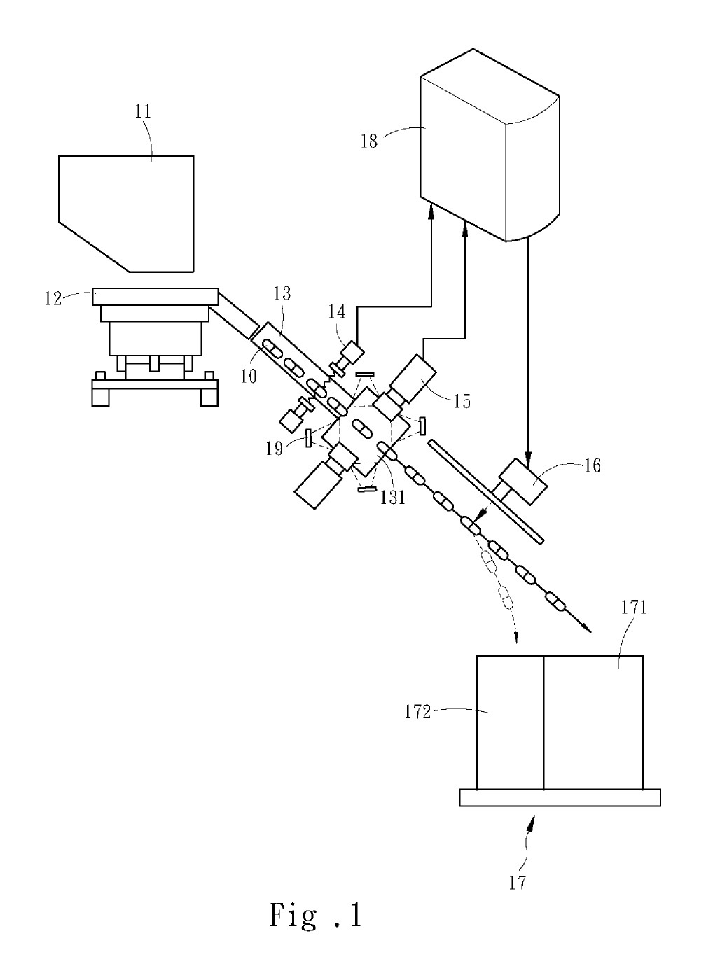

Please refer to FIG. 1, which is a schematic view showing a system for inspecting appearance of pellet type medicines according to the present invention. The present invent is suitable for automatically screening and classifying the appearances of plural pellet type medicines 10. The system includes a material supplying device 11, for providing the pellet type medicines 10, an arranging device 12, for receiving the pellet type medicines 10 from the material supplying device 11 and arranging thereof into a row, an oriented sliding channel 13, connected to the arranging device 12 for guiding the pellet type medicines 10 to slide down, and having an inspecting region 131 located at the end of the oriented sliding channel 13, a detecting device 14, mounted aside the oriented sliding channel 13 for sensing each of the slid-down pellet type medicines 10, at least two image gathering devices 15, located around the inspecting region 131, which is located at the end of the oriented sliding channel 13, for gathering appearance images of the pellet type medicines 10, which slide to the inspecting region 131, from multiple angles, and a classification controlling device 16, mounted at the rear end of the inspecting region 131 for picking out the pellet type medicine 10 with defective appearance when at least one of the image gathering device 15 gathers the image showing the defective appearance of the medicine 10.

The system further includes a material collecting device 17, mounted below the oriented sliding channel 13 for collecting the screened pellet type medicines 10, and an image processing device 18, electrically connected with the detecting device 14, the image gathering devices 15 and the classification controlling device 16, for providing the operation basis for the image gathering devices 15 and the classification controlling device 16 according to the records of the pellet type medicines 10 from the detecting device 14, for example, it can mark the pellet type medicines 10 by time and compare and analysis thereof based on the appearance images in multiple angles received from the image gathering devices 15, so that when the appearance of the pellet type medicine 10 does not conform to the standard, the image processing device 18 can control the classification controlling device 16 to remove the appearance defective pellet type medicines 10, wherein the classification controlling device 16 can be a gas nozzle for blowing the appearance defective pellet type medicines 10 away the original pathway thereof.

Besides, the material collecting device 17 can further include a good product collecting device 171 and a defective product collecting device 172, wherein the good product collecting device 171 is just located at the position where the pellet type medicines 10 will naturally drop from the oriented sliding channel 13 so as to collect the pellet type medicines 10 with good appearance, and the defective product collecting device 172 is located aside the good product collecting device 171 so as to collect the pellet type medicines 10 with defective appearance which depart from the pathway.

In addition, around the image gathering devices 15, plural illuminating devices 19 are mounted, for providing light to the inspection region 131 so as to give the images gathered by the image gathering devices 15 sufficient brightness.

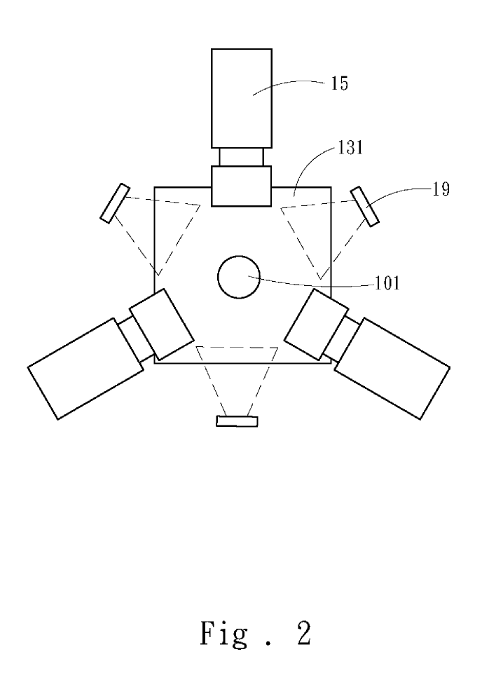

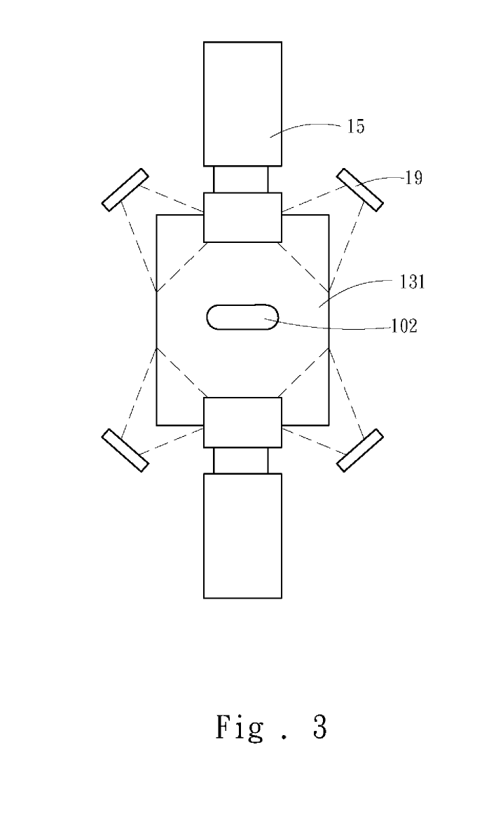

Please refer to FIGS. 2 and 3, which are schematic views showing the arrangements for gathering images of pellet type medicines according to the present invention. Because the pellet type medicines 10 can be capsules 101 or pills 102, in which the capsules 101 have a cylinder shape and the pills 102 have a flat circular shape with two sides, which are basically different, the arrangements for image gathering are also different. For capsules 101, it can be three image gathering devices 15 located around the inspecting region 131 to gather the images of the capsules 101 from 360 degrees, and three illuminating devices 19 respectively located between the image gathering devices 15 to provide the capsules 101 omni-directional light sources (as shown in FIG. 2).

For pills 102, it can be two image gathering devices 15 respectively located at the top and the bottom of the inspecting region 131 to gather the images of the pills 101 from the top and the bottom, and two illuminating devices 19 located at two sides of each image gathering device 15 to provide the pills 102 omni-directional light source (as shown in FIG. 3).

According to the present invention, after the pellet type medicines 10 are arranged into a row, they will slide on the oriented sliding channel 13 for sequentially sliding down, and when the pellet type medicines 10 move on the oriented sliding channel 13, the image processing device 18, according to the records from the detecting device 14, will gather and classify the images, and then control the classification controlling device 16 to act on the appearance defective medicines 10 so as to make the appearance defective pellet type medicines 10 departing from the dropping pathway.

In the aforesaid, the present invention can rapidly and automatically inspect and screen the appearance of plural pellet type medicines 10. Only by adjusting the number and angle of the image gathering devices 15 and by flexibly modifying the settings of image processing and analysis and the settings of defective parameters, the present invention can be applied to inspect and screen the appearance of various sizes of pellet type medicines 10, and in practice, for improving inspection speed and quality, a criterion for judging the defects also can be generated through statistic calculation.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A system for inspecting appearance of pellet type medicines, suitable for automatically screening and classifying the appearance of plural pellet type medicines, the system comprising:
a material supplying device, for providing the pellet type medicines;
an arranging device, for receiving the pellet type medicines from the material supplying device and arranging thereof into a row;
an oriented sliding channel, connected to the arranging device for guiding the pellet type medicines to slide down, and having an inspecting region located at the end there;
a detecting device, mounted aside the oriented sliding channel for sensing each of the slid-down pellet type medicines;
at least two image gathering devices, located around the inspecting region for gathering appearance images of the pellet type medicines, which slide to the inspecting region, from multiple angles;
a classification controlling device, mounted at the rear end of the inspecting region for picking out the pellet type medicine with defective appearance when at least one of the image gathering device gathers the image showing the defective appearance of the medicine;
a material collecting device, mounted below the oriented sliding channel for collecting the screened pellet type medicines; and
an image processing device, electrically connected with the detecting device, the image gathering devices and the classification controlling device, for analyzing and classifying the pellet type medicines according to the records from the detecting device and the image information obtained by the image gathering devices, and for controlling the operation of the classification controlling device related to the appearance defective pellet type medicines so as to depart the appearance defective pellet type medicines from the dropping pathway.

2. The system as claimed in claim 1, wherein the pellet type medicines are one of capsules and pills.

3. The system as claimed in claim 1, wherein plural illuminating devices are mounted around the image gathering devices for providing light to the inspection region.

4. The system as claimed in claim 1, wherein the classification controlling device comprises a gas nozzle for blowing the appearance defective pellet type medicines away the dropping pathway.

5. The system as claimed in claim 1, wherein the material collecting device further comprises a good product collecting device, for collecting the pellet type medicines with good appearance, and a defective product collecting device, located aside the good product collecting device, for collecting the pellet type medicines with defective appearance.

6. A method for inspecting appearance of pellet type medicines, suitable for automatically screening and classifying the appearance of plural pellet type medicines, the method comprising steps of:
arranging the pellet type medicines into a row; and
sequentially sliding down the arranged pellet type medicines via an oriented sliding channel and collecting the dropped pellet type medicines,
wherein when the pellet type medicines move on the oriented sliding channel, an image processing device classifies the pellet type medicines according to records of detecting signals and gathered images, and controls the operation of a classification controlling device related to the appearance defective pellet type medicines, so as to depart the appearance defective pellet type medicines from the dropping pathway.

7. The method as claimed in claim 6, wherein the pellet type medicines are one of capsules and pills.

8. The method as claimed in claim 6, wherein the classification controlling device comprises a gas nozzle for blowing the appearance defective pellet type medicine away the dropping pathway.
